(19) United States
(12) Patent Application Publication
(10) Pub. No.: US 2026/0368847 A1
(43) Pub. Date: Nov. 19, 2026

(54) Method and Apparatus for Improving the Scalability of GPU Architecture

(71) Applicant: BEIJING FANTASY TECHNOLOGY CO., LTD., Beijing (CN)

(72) Inventor: Xile YANG, Beijing (CN)

(73) Assignee: BEIJING FANTASY TECHNOLOGY CO., LTD., Beijing (CN)

(21) Appl. No.: 19/675,609

(22) Filed: May 13, 2026

(30) Foreign Application Priority Data
May 15, 2025 (CN) 2025106259412

(51) Int. Cl. G06T 1/20; G06F 9/48

(52) U.S. Cl. CPC G06T 1/20; G06F 9/4881

(57) ABSTRACT

The present invention relates to the technical field of high-performance computing and provides a method and apparatus for improving the scalability of GPU architecture. A system-level common module splits a total workload into a plurality of first-level workloads and distributes the first-level workloads to corresponding super scalable groups; an SSG common module of each super scalable group splits the first-level workloads into a plurality of second-level workloads and distributes the second-level workloads to corresponding SPCs, such that each SPC processes the received second-level workload. By dividing multi-level common modules, the present invention simplifies the hardware implementation of GPU, reduces the pressure on the common modules and on the connections between the common modules and each SPC, thereby breaking through the scalability and performance bottlenecks of GPU, and significantly improving the scalability of GPU systems.

### CROSS-REFERENCE TO RELATED APPLICATION

This application claims priority to Chinese Patent Application No. 202510625941.2, filed with the Patent Office of the People's Republic of China on May 15, 2025, and entitled "Method and Apparatus for Improving Scalability of GPU Architecture".

### TECHNICAL FIELD

The present invention relates to the technical field of high-performance computing, and in particular, to a method and apparatus for improving the scalability of GPU architecture.

### BACKGROUND

Graphics Processing Units (GPUs) support high-performance parallel computing and are therefore widely used to accelerate computer graphics applications.

In the prior art, to improve computing performance and scalability, a GPU architecture typically includes a plurality of Shader Processing Clusters (SPCs), and an SPC may include a plurality of Shader Execution Units (SEUs). A plurality of SPCs share a single common module, which receives input data, transmits output images, and accesses the system-level cache through the connections between the common module and each SPC.

However, as the number of SPCs sharing the common module increases to a certain threshold, the pressure on the common module and on the connections between the common module and each SPC also increases significantly, resulting in bottlenecks in the scalability and performance of GPU.

In view of the above, overcoming the drawbacks existing in the prior art is an urgent problem to be solved in the technical field.

### SUMMARY

The technical problem to be solved by the present invention is to provide a method and apparatus for improving the scalability of GPU architecture. The object thereof is to first distribute a total workload to each super scalable group, and then distribute the corresponding first-level workload to each SPC within each super scalable group, so as to solve the bottleneck problem of GPU performance caused by a relatively large number of SPCs sharing the common module.

The present invention adopts the following technical solutions:
In a first aspect, the present invention provides a method for improving the scalability of GPU architecture, comprising:
splitting, by a system-level common module, a total workload into a plurality of first-level workloads and distributing the first-level workloads to corresponding super scalable groups; and
splitting, by an SSG common module of each super scalable group, the first-level workloads into a plurality of second-level workloads and distributing the second-level workloads to corresponding SPCs, such that each SPC processes the received second-level workload.

In a second aspect, the present invention further provides an apparatus for improving the scalability of GPU architecture, which is configured to implement the method for improving the scalability of GPU architecture according to the first aspect. The apparatus for improving the scalability of GPU architecture comprises a system-level common module and a plurality of super scalable groups, wherein each super scalable group comprises an SSG common module and a plurality of SPCs;

the system-level common module is configured to split a total workload into a plurality of first-level workloads and distribute the first-level workloads to the SSG common modules of corresponding super scalable groups; and

the SSG common module is configured to split the first-level workload into a plurality of second-level workloads and distribute the second-level workloads to corresponding SPCs, such that each SPC processes the received second-level workload.

In a third aspect, the present invention further provides an apparatus for improving the scalability of GPU architecture, comprising:
at least one processor; and
a memory communicatively coupled to at least one processor;
wherein the memory has stored thereon instructions executable by at least one processor, and the instructions, when executed by the processor, are configured to implement the method for improving the scalability of GPU architecture according to the first aspect.

In a fourth aspect, the present invention further provides a non-volatile computer storage medium having stored thereon computer-executable instructions, and the computer-executable instructions, when executed by one or more processors, are configured to implement the method for improving the scalability of GPU architecture according to the first aspect.

In a fifth aspect, provided is a chip comprising a processor and an interface. The chip is configured to call and execute a computer program stored in the memory, so as to implement the method for improving the scalability of GPU architecture according to the first aspect.

In a sixth aspect, provided is a computer program product comprising instructions which, when executed on a computer or processor, cause the computer or processor to implement the method for improving the scalability of GPU architecture according to the first aspects.

In a seventh aspect, provided is a system for improving the scalability of GPU architecture. The system comprises the apparatus for improving the scalability of GPU architecture according to the second aspect, and employs the method for improving the scalability of GPU architecture according to the first aspect to realize interaction of the apparatus for improving the scalability of GPU architecture according to the second aspect.

Compared with the prior art, the present invention has at least the following beneficial effects:

The embodiments of the present invention provide a hierarchical GPU architecture that splits the task of distributing computing workloads to each SPC into multiple levels of subtasks for execution. First, the total workload is distributed to each super scalable group, and then the corresponding first-level workload is distributed to each SPC within each super scalable group. This minimizes the control logic and the number of connections between the common modules and the SPCs, as well as the super scalable groups, thereby simplifying the hardware implementation of GPU, reducing the pressure on the common modules and on the connections between the common modules and each SPC, further breaking through the scalability and performance bottlenecks of GPU, and significantly improving the scalability of GPU systems.

### BRIEF DESCRIPTION OF FIGURES

To describe the technical solutions in embodiments of the present invention more clearly, the accompanying drawings required for use in the embodiments of the present invention are briefly introduced below. Obviously, the accompanying drawings described below are merely some embodiments of the present invention. For those of ordinary skill in the art, other drawings may be obtained from these drawings without creative efforts.

FIG. 1 is a schematic diagram of a GPU architecture in the prior art according to an embodiment of the present invention.

FIG. 2 is a schematic flowchart of a method for improving the scalability of GPU architecture according to an embodiment of the present invention.

FIG. 3 is a schematic diagram of a hierarchical GPU architecture according to an embodiment of the present invention.

FIG. 4 is a schematic flowchart of Step 10 according to an embodiment of the present invention.

FIG. 5 is a schematic diagram of another hierarchical GPU architecture according to an embodiment of the present invention.

FIG. 6 is a schematic diagram of the structure and connections of a system-level entry module according to an embodiment of the present invention.

FIG. 7 is a schematic flowchart of Step 101 according to an embodiment of the present invention.

FIG. 8 is a schematic flowchart of Step 102 according to an embodiment of the present invention.

FIG. 9 is a schematic diagram of the structure and connections of an SSG entry module according to an embodiment of the present invention.

FIG. 10 is a schematic flowchart of Step 20 according to an embodiment of the present invention.

FIG. 11 is a schematic flowchart of another method for improving the scalability of GPU architecture according to an embodiment of the present invention.

FIG. 12 is a schematic architectural diagram of an apparatus for improving the scalability of GPU architecture according to an embodiment of the present invention.

### DETAILED DESCRIPTION

To make the objectives, technical solutions, and advantages of the present invention clearer, the present invention will be further described in detail below with reference to the accompanying drawings and embodiments. It should be understood that the specific embodiments described herein are merely intended to explain the present invention rather than to limit the present invention.

Unless the context otherwise requires, throughout the specification and claims, the term "comprising" shall be construed as open-ended, meaning "including, but not limited to". In the description of the specification, the terms "one embodiment", "some embodiments", "exemplary embodiment", "example", "specific example", "some examples", and the like are intended to indicate that specific features, structures, materials, or characteristics associated with such embodiments or examples are included in at least one embodiment or example of the present disclosure. The schematic representations of the above terms do not necessarily refer to the same embodiment or example. Furthermore, the specific features, structures, materials, or characteristics described may be included in any one or more of the embodiments or examples in any suitable manner. That is, although they may be carried in the embodiments or examples referred to by the above terms due to the order and position of their appearance, there is no restriction that they may be carried in a combined manner by a single embodiment or example.

In the description of the present invention, it should be understood that the orientation or positional relationships indicated by the terms "center", "upper", "lower", "front", "rear", "left", "right", "vertical", "horizontal", "top", "bottom", "inner", "outer", etc., are based on the orientation or positional relationships shown in the accompanying drawings. They are merely for the convenience of describing the present disclosure and simplifying the description, rather than indicating or implying that the mentioned devices or elements must have a specific orientation and be constructed and operated in a specific orientation, and therefore, these terms cannot be construed as a limitation on the present disclosure.

In the description of the present invention, the terms "first" and "second" are used for descriptive purposes only and shall not be construed as indicating or implying relative importance or implicitly indicating the number of the technical features indicated. Thus, features defined with "first" and "second" may explicitly or implicitly include one or more of such features. In the description of the embodiments of the present disclosure, "a plurality of" means two or more, unless otherwise stated. In addition, for example, in the description, the same type of nouns may be described as two independent entities by adding "A" and "B" at the end. In such cases, the corresponding features defined with "A" and "B" are used only to distinguish between entities of the same type for descriptive purposes and shall not be construed as indicating or implying relative importance or implicitly indicating the number of technical features indicated.

In describing some embodiments, the terms "coupled", "coupled to", "connected", and their derivative expressions may be used. For example, the term "connected" may be used in describing some embodiments to indicate that two or more components are in direct physical or electrical contact with each other. As another example, the term "coupled" may be used in describing some embodiments to indicate that two or more components are in direct physical or electrical contact with each other. However, the terms "connected" or "coupled" may also mean that two or more components are not in direct contact with each other but still cooperate or interact with each other, such as "optical path coupling", "wireless connection", and the like. The embodiments disclosed herein are not necessarily limited to the context of the present invention.

In the description of the present invention, reference will be made to the expression "A and/or B" (wherein A and B are used to formally represent specific feature contents), and the corresponding expression covers the following three combinations: A alone, B alone, and a combination of A and B.

As used herein, "about", "substantially", or "approximately" include the stated value and an average value within an acceptable deviation range of the specified value, as determined by one of ordinary skill in the art in view of the measurement under discussion and errors associated with the measurement of the particular quantity (i.e., limitations of the measurement system).

GPUs are widely used to accelerate computer graphics applications, such as rendering tools for computer games and computer-aided design. GPUs are also extensively applied in general-purpose computing applications, such as the currently popular artificial intelligence applications based on Large Language Models (LLMs).

A computer graphics processing system processes graphics data (including raw data and vertex data) from computer graphics applications (e.g., computer games) and generates rendered images through a rendering pipeline.

Three-dimensional models in computer graphics applications are defined using primitives, which include, but are not limited to, triangles, lines, and points. Each primitive is defined by vertices representing its position in three-dimensional space, as well as lighting and shading attributes. In a three-dimensional model, geometric data of primitives and vertices is transmitted as input data to the computer graphics processing system for geometric processing, including transforming primitives into screen space and culling invisible primitives within the screen space. The geometric data processed by geometric processing is transmitted to the fragment processing pipeline for rendering in the computer graphics processing system. After rendering, the three-dimensional model generates an output image that is displayed on a display unit (e.g., a display screen).

Computer graphics processing systems have many different implementations, including Immediate Mode Rendering (IMR) and tile-based rendering. In immediate mode rendering, primitives are directly transmitted to the fragment processing pipeline after geometric processing. Therefore, during fragment processing, the processed primitives in the computer graphics processing system may be located at any position on the screen. In tile-based rendering, the screen is divided into a number of rectangular tiles. After geometric processing, primitives are binned into tiles at specific positions on the screen, and fragment processing is performed separately in each tile.

Computer graphics workloads from applications are transmitted to GPU hardware through a graphics control flow, including rendering states, geometric data, shader code and data, so as to process geometric data, execute shader code, and generate a final output image in the SEUs of GPU hardware.

In the prior art, to improve computing performance and scalability, a plurality of SEUs may be used to form a graphics pipeline, and each SPC includes a corresponding graphics pipeline. To achieve different performance objectives, GPU architecture may include a plurality of SPCs when configuring the GPU system.

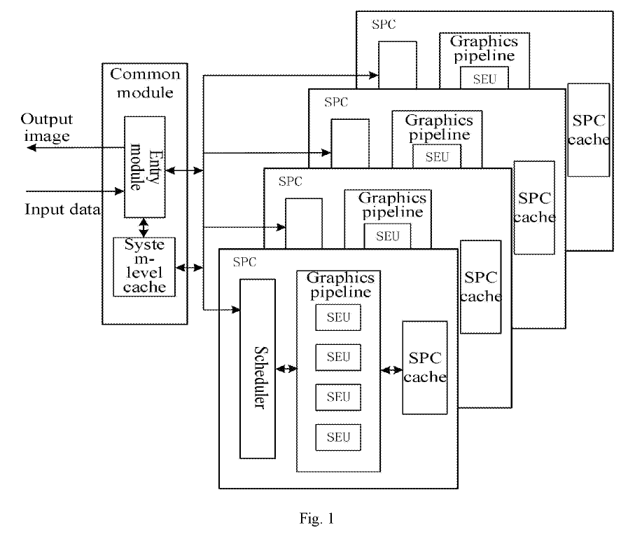

FIG. 1 shows a GPU architecture. Each SPC includes a scheduler, a graphics pipeline composed of four SEUs, and an SPC cache. Four SPCs share a common module including an entry module and a system-level cache, and the entry module and the system-level cache are respectively connected to each SPC. The graphics control flow of the workload is distributed from the entry module to each SPC in the form of input data, then scheduled and distributed by the scheduler in the corresponding SPC to each SEU in the graphics pipeline, and processed by the SEUs. The required data is acquired from the system-level cache when the entry module distributes the workload or the SPC processes the received workload; the SPC also acquires the required data from the SPC cache when processing the received workload. Each SPC sends an end signal to the entry module upon completion of processing. When end signals from all SPCs assigned with tasks are received, the entry module merges them to generate a global end signal, and the configuration register corresponding to the workload updates relevant parameters. In the above process, when the total number of SEUs in the SPCs is large, hardware costs, clock cycles for tile distribution, and clock cycles for merging end signals all increase, such that processing performance is likely to be affected.

When the number of SPCs connected to the shared common module increases (e.g., when 16 SPCs share one common module), the pressure on the common module and on the connections between the common module and the SPCs also increases, leading to greater difficulty and complexity in hardware implementation and control logic, thereby resulting in bottlenecks in the scalability and performance of GPU.

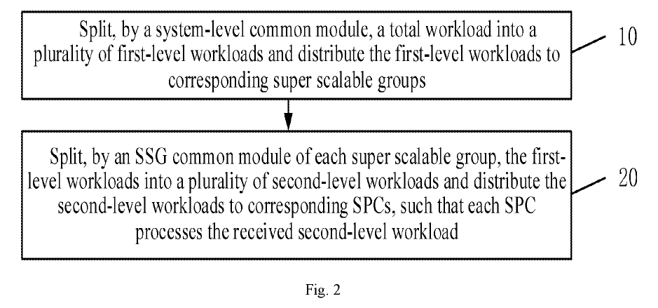

To solve the above problems, as shown in FIG. 2, an embodiment of the present invention provides a method for improving the scalability of GPU architecture, comprising:

Step 10: A system-level common module splits a total workload into a plurality of first-level workloads and distributes the first-level workloads to corresponding super scalable groups.

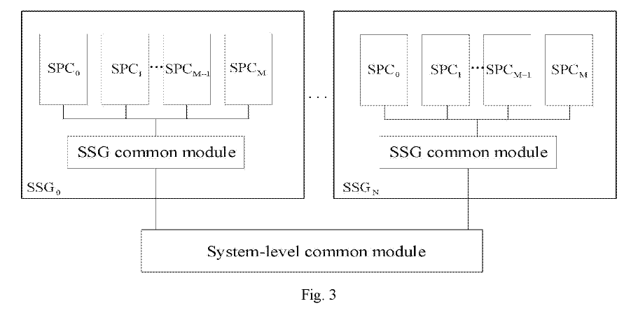

As shown in FIG. 3, an embodiment of the present invention provides an apparatus for improving the scalability of GPU architecture, comprising one system-level common module and N+1 super scalable groups (Supper Scalable Groups, abbreviated as SSGs). One super scalable group comprises M+1 SPCs and one SSG common module, and the M+1 SPCs are connected to the SSG common module. Each SPC comprises a plurality of SEUs, a scheduler, an SPC cache, and other general modules, as shown in FIG. 1. The values of M and N are respectively determined by a person skilled in the art according to specific application scenarios.

The number of SPCs in a super scalable group and the number of super scalable groups in a GPU core may be configured according to different performance objectives of the GPU architecture. For example, one system-level common module is connected to each SSG common module in N+1 super scalable groups; each super scalable group comprises four SPCs and one SSG common module, and the four SPCs are connected to the SSG common module.

Step 20: The SSG common module of the super scalable group splits the first-level workloads into a plurality of second-level workloads and distributes the second-level workloads to corresponding SPCs, such that each SPC processes the received second-level workload.

The embodiments of the present invention provide a hierarchical GPU architecture that splits the task of distributing computing workloads to each SPC into two levels of subtasks for execution. First, the total workload is distributed to each super scalable group, and then the corresponding first-level workload is distributed to each SPC within each super scalable group. This minimizes the control logic and the number of connections between the two levels of common modules and the SPCs, as well as the super scalable groups, thereby simplifying the hardware implementation of GPU, reducing the pressure on the common modules and on the connections between the common modules and each SPC, further breaking through the scalability and performance bottlenecks of GPU, and significantly improving the scalability of GPU systems.

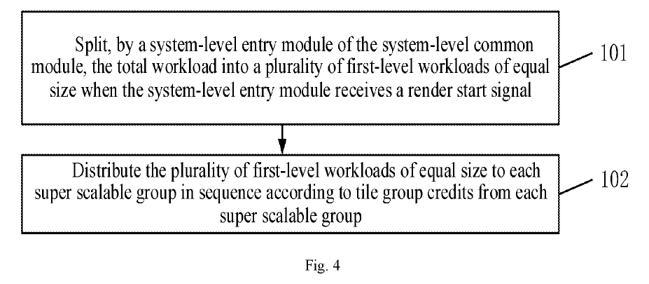

To further solve the above problems, the process of processing the total workload from an application is described below by taking tile-based rendering as an example. As shown in FIG. 4, Step 10 includes:

Step 101: When a system-level entry module of the system-level common module receives a render start signal, the system-level entry module splits the total workload into a plurality of first-level workloads of equal size.

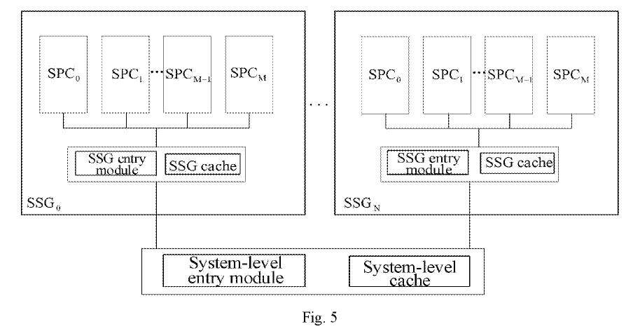

As shown in FIG. 5, the system-level common module according to an embodiment of the present invention comprises a system-level entry module and a system-level cache, and the SSG common module comprises an SSG entry module and an SSG cache. The total workload is distributed in two levels in the embodiment of the present invention: first, the total workload is split into a plurality of first-level workloads, which are scheduled from the system-level entry module to the SSG entry modules; then, each SSG entry module further splits the first-level workload distributed to itself into a plurality of second-level workloads, which are distributed to the SPCs in the corresponding SSG and further dispatched to the SEUs in the graphics pipelines within the SPCs, for the SEUs to process the second-level workloads. During the processing of the first-level workloads distributed by the system-level common module in each SSG, the system-level common module acquires required data from the system-level cache; during the processing of the second-level workloads distributed by the SSG common module in each SPC, the SSG common module acquires required data from the SSG cache.

It should be noted that, in the embodiment of the present invention, the manner of distributing the total workload to two levels is merely one specific example of the method for improving the scalability of GPU architecture according to the embodiment of the present invention, and is not intended to limit the present invention. Those skilled in the art may divide multi-level common modules to process workloads hierarchically with reference to the embodiment of the present invention.

Hereinafter, the distribution process of an SSG distribution module will be described. The distribution process of a system-level distribution module is described as follows:

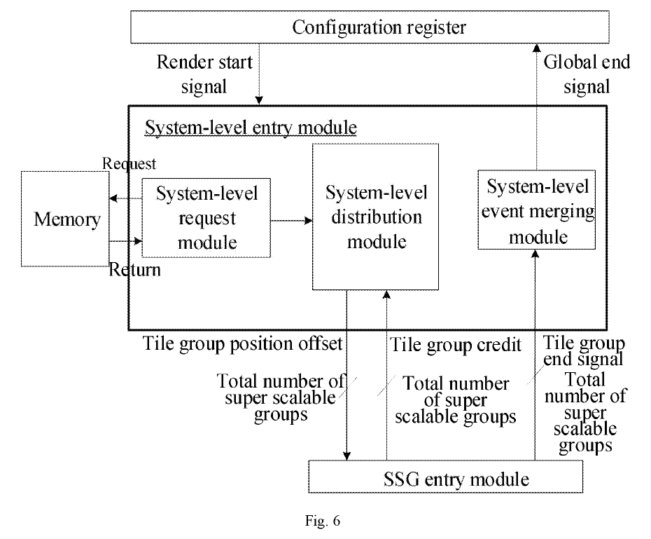

The total workload refers to the current rendering task to be processed, which includes tile groups to be rendered and rendering parameters. As shown in FIG. 6, a configuration register corresponding to the total workload transmits a render start signal to the system-level entry module. Upon receiving the render start signal, a system-level request module in the system-level entry module first acquires tile groups to be rendered that are required for processing the total workload. The system-level request module requests and acquires the tile groups to be rendered in tiled format on the screen from memory, such as the screen coordinates of the tile groups and the base addresses of geometric data of primitives to be processed in the tile groups. After acquiring the tile groups, the system-level request module transmits them to the system-level distribution module, and the system-level distribution module distributes the tile groups to different super scalable groups, so as to split the total workload into a plurality of first-level workloads and distribute them. The corresponding first-level workloads refer to the current sub-rendering tasks to be processed, and each sub-rendering task also comprises tiles to be rendered and rendering parameters. The system-level distribution module may adopt different distribution strategies during distribution, such as Round-Robin mode and demand mode. The Round-Robin mode refers to distributing tile groups to each SSG in a fixed order; in this mode, the current actual performance of the SSGs is not considered, and the first-level workloads are distributed to each SSG in sequence until all the first-level workloads are distributed. The demand mode refers to dynamically distributing the first-level workloads according to the current actual performance of each SSG; in this mode, tasks are each distributed to SSGs with higher performance and lower load, so as to shorten processing time and improve overall resource utilization and efficiency.

In an alternative embodiment, tile groups of equal size may be distributed to each super scalable group; for example, a tile group of k×k tiles is distributed to each super scalable group. The size of the tile group may be set by a software driver through a configuration register. To better balance the computational workload of SPCs and SEUs in the GPU system, an optimal tile group size may be obtained through experiments, thereby improving the overall rendering performance of GPU systems.

Step 102: The plurality of first-level workloads of equal size is distributed to each super scalable group in sequence according to tile group credits from each super scalable group.

The system-level distribution module receives tile group credits from each super scalable group and distributes tile group position offsets to each currently available super scalable group. The tile group credit is calculated based on the tile credits of SPCs in each super scalable group, wherein the tile group credit is the sum of all tile credits in the super scalable group; or the tile group credit is the maximum value among all tile credits in the super scalable group. The tile credits may be defined as the capability of an SPC to receive and process the workload of new tiles, or as the number of tiles being processed in the SPC.

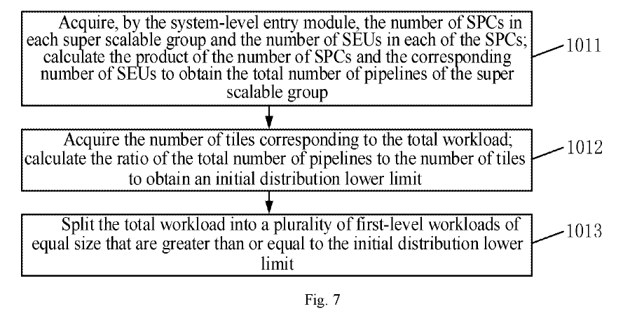

During initial distribution, as shown in FIG. 7, Step 101 comprises:

Step 1011: The system-level entry module acquires the number of SPCs in each super scalable group and the number of SEUs in each of the SPCs, and calculates the product of the number of SPCs and the corresponding number of SEUs to obtain the total number of pipelines of the super scalable group.

The number of tiles distributed initially shall be equal to or greater than the total number of graphics pipelines in each super scalable group. For example, in a GPU system, each super scalable group is configured with four SPCs, and each SPC has four SEUs, such that the total number of pipelines of the super scalable group is 16.

Step 1012: The number of tiles corresponding to the total workload is acquired, and the ratio of the total number of pipelines to the number of tiles is calculated to obtain an initial distribution lower limit.

For example, when the tile group size is 2×2 tiles, the number of tiles corresponding to the total workload is 4; since the total number of pipelines is 16, the initial distribution lower limit is 4, i.e., at least four tile groups are distributed to the super scalable group in the initial stage. Alternatively, when the tile group size is 4×4 tiles, the number of tiles corresponding to the total workload is 16; since the total number of pipelines is 16, the initial distribution lower limit is 1, i.e., at least one tile group is distributed to the super scalable group in the initial stage.

Step 1013: The total workload is split into a plurality of first-level workloads of equal size that are greater than or equal to the initial distribution lower limit.

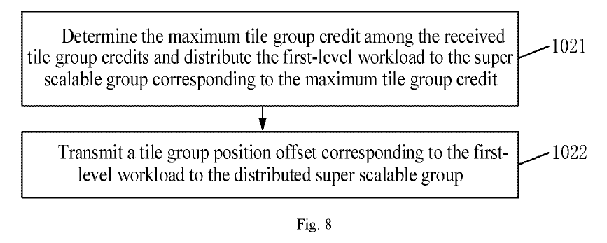

Further tile group distribution may be implemented according to tile group credits fed back by the SSG distribution module. As shown in FIG. 8, Step 102 comprises:

Step 1021: The maximum tile group credit among the received tile group credits is determined, and the first-level workload is distributed to the super scalable group corresponding to the maximum tile group credit.

The system-level distribution module dynamically distributes tile groups to each super scalable group according to the tile group credits. In one embodiment, the distribution strategy is as follows: each subsequent tile group is distributed to the super scalable group corresponding to the maximum tile group credit, i.e., each tile group is distributed to the super scalable group with the highest processing capability for scheduling. In alternative embodiments, other distribution strategies (e.g., Round-Robin mode) may also be used to distribute tile groups, so as to achieve higher GPU performance.

Step 1022: The tile group position offset corresponding to the first-level workload is transmitted to the distributed super scalable group.

The tile group position offset corresponding to the first-level workload refers to the on-screen position offset of the tile group to be rendered for processing the first-level workload. In embodiments of the present invention, a base address is added to the tile group position offset to obtain the memory address of the tile group; the tile group is acquired from memory by the system-level request module and transmitted from the system-level distribution module to the corresponding super scalable group.

In an alternative embodiment, to reduce the latency from the system-level distribution module to the SSG request module in the SSG entry module, tile group position offsets may be sequentially transmitted to the distributed super scalable groups via a separate first-in-first-out queue/module in the system-level distribution module.

Compared with the prior art, the number of super scalable groups in embodiments of the present invention is several times that of SPCs in the prior art. By using super scalable groups, the pressure on the system-level common module, on the connections between the system-level common module and the SSG entry modules of the super scalable groups, and on the connections between the SSG entry modules and the SPCs is maintained at a low level, which significantly reduces the difficulty and complexity in hardware implementation and control logic, and reduces the latency of searching for the next graphics pipeline during tile group distribution.

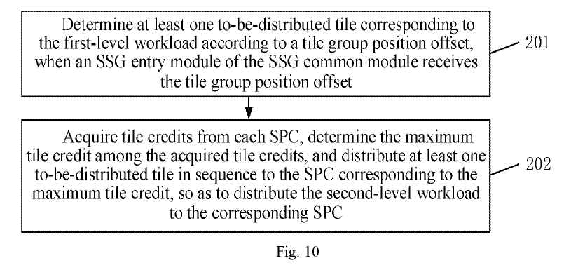

To further describe the distribution process of the SSG entry module, as shown in FIG. 10, when the first-level workload distributed by the system-level common module to the super scalable group corresponds to at least one to-be-distributed tile, Step 20 comprises:

Step 201: When the SSG entry module of the SSG common module receives a tile group position offset, at least one to-be-distributed tile corresponding to the first-level workload is determined according to the tile group position offset.

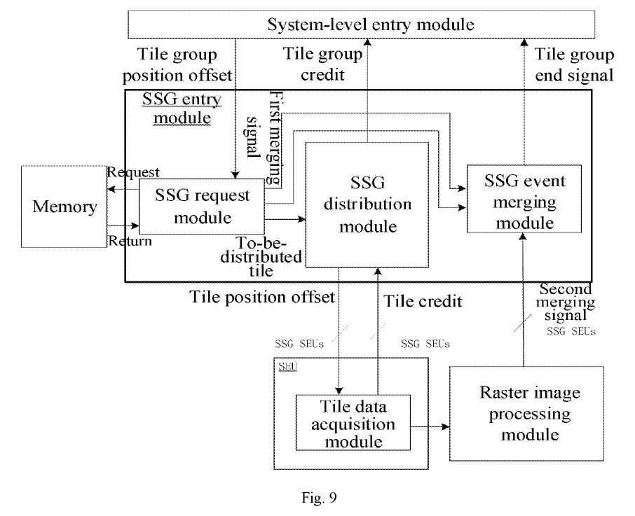

The to-be-distributed tile corresponding to the first-level workload refers to a tile to be rendered for a sub-rendering task of the first-level workload. As shown in FIG. 9, the SSG request module acquires the corresponding to-be-distributed tile from memory according to the tile group position offset and transmits it to the SSG distribution module; this process is analogous to the interaction between the system-level request module and the system-level distribution module.

Step 202: Tile credits are acquired from each SPC, and the maximum tile credit among the acquired tile credits is determined. At least one to-be-distributed tile is distributed to the SPC corresponding to the maximum tile credit, so as to distribute the second-level workload to the corresponding SPC.

The SSG distribution module dynamically distributes the to-be-distributed tiles to each SPC according to the tile credits, and the corresponding distribution strategy may be analogous to the distribution strategy in which the system-level distribution module distributes tile groups to each super scalable group.

As shown in FIG. 9, after the to-be-distributed tile is distributed to an SPC, the SPC distributes and schedules the tile to a corresponding SEU in a graphics pipeline, so as to render the tile by a tile data acquisition module in the SEU; during distribution to the SEU, a tile position offset of the to-be-distributed tile is transmitted to the tile data acquisition module in the corresponding SEU; the to-be-distributed tile is transmitted from the tile data acquisition module to a Raster Image Processing (RAST) module for rendering. Here, "SSG SEUs" in FIG. 9 refers to all SEU modules in one SSG.

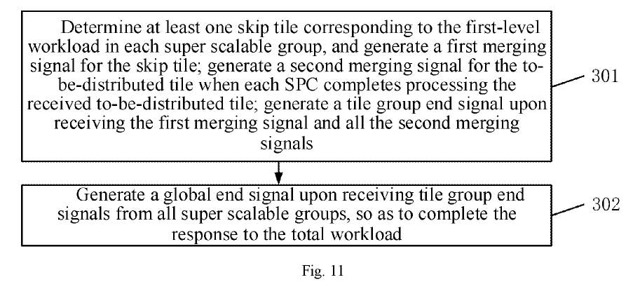

To illustrate the process after rendering is completed, as shown in FIG. 11, when the second-level workload corresponds to at least one skip tile, after each SPC processes the received second-level workload, the method further comprises:

In Step 301, at least one skip tile corresponding to the first-level workload is determined in each super scalable group, and a first merging signal for the skip tile is generated; when each SPC completes processing the received to-be-distributed tile, a second merging signal for the to-be-distributed tile is generated; a tile group end signal is generated upon receiving the first merging signal and all the second merging signals.

The skip tile corresponding to the first-level workload refers to a tile that does not need to be rendered during the processing of a sub-rendering task of the first-level workload. In the process of graphics rendering, it is often required to skip certain tiles according to a predetermined strategy, i.e., such tiles do not need to be rendered and are thus defined as skip tiles.

For a super scalable group, when the SSG request module acquires the last skip tile to be processed for the first-level workload from memory, a first merging signal is generated and transmitted to the SSG event merging module. When the corresponding raster image processing module in the SPC completes rendering of the to-be-distributed tile, a second merging signal is generated and transmitted to the SSG event merging module. The SSG event merging module generates a tile group end signal upon receiving the first merging signal and all the second merging signals, and transmits the signal to the system-level event merging module in the system-level entry module.

In an alternative embodiment, each SSG distribution module may repeatedly acquire the to-be-distributed tile and skip tile corresponding to the first-level workload distributed to the super scalable group. Although the corresponding read bandwidth is increased, it is easier to process rendering end events according to the positions of the processed tiles in the SSG distribution module.

In the embodiment of the present invention, the number of graphics pipelines is several times that in the prior art, thereby reducing hardware implementation complexity and the latency of searching for the optimal graphics pipeline during tile distribution.

In Step 302, a global end signal is generated upon receiving tile group end signals from all super scalable groups, so as to complete the response to the total workload.

As shown in FIG. 6, the system-level event merging module generates a global end signal upon receiving tile group end signals from all the distributed super scalable groups, and transmits the signal to the configuration register corresponding to the total workload.

It should be noted that the method for improving the scalability of GPU architecture according to an embodiment of the present invention provides a limited improvement in GPU performance, but can greatly simplify hardware implementation and reduce the latency of tile distribution in a GPU system with a large number of SPCs and SEUs, thereby significantly improving the scalability of GPU architecture and laying a necessary foundation for breaking through performance bottlenecks in subsequent GPU function expansion design.

In an alternative embodiment, as shown in FIG. 3, an embodiment of the present invention further provides an apparatus for improving the scalability of GPU architecture, comprising a system-level common module and a plurality of super scalable groups, wherein each super scalable group comprises an SSG common module and a plurality of SPCs.

The system-level common module is configured to split a total workload into a plurality of first-level workloads and distribute the first-level workloads to the SSG common modules of corresponding super scalable groups.

The SSG common module is configured to split the first-level workload into a plurality of second-level workloads and distribute the second-level workloads to corresponding SPCs, such that each SPC processes the received second-level workload.

In one embodiment, as shown in FIG. 6, the system-level common module comprises a system-level entry module and a system-level cache, wherein the system-level cache refers to a cache and serves as a system-level general module. The SSG common module comprises an SSG entry module and an SSG cache, wherein the SSG cache refers to a cache and serves as an SSG-level general module.

The SSG entry module is configured to determine at least one to-be-distributed tile corresponding to the first-level workload according to a tile group position offset upon receiving the tile group position offset.

The SSG entry module is further configured to acquire tile credits from each SPC, determine the maximum tile credit among the acquired tile credits, and distribute at least one to-be-distributed tile to the SPC corresponding to the maximum tile credit, so as to distribute the second-level workload to the corresponding SPC.

The SSG cache is configured to cache data required during the operation of each SPC for the second-level workloads contained in the SSG.

In one embodiment, as shown in FIG. 6, the system-level entry module comprises a system-level request module, a system-level distribution module and a system-level event merging module; as shown in FIG. 9, the SSG entry module comprises an SSG request module, an SSG distribution module, and an SSG event merging module.

The system-level distribution module is configured to split a total workload into a plurality of first-level workloads of equal size and distribute the plurality of first-level workloads of equal size to each SSG request module in sequence according to tile group credits from each super scalable group.

The SSG request module is configured to determine at least one skip tile corresponding to the first-level workload in each super scalable group, generate a first merging signal for the skip tile, and transmit the first merging signal to the SSG event merging module.

The SSG distribution module is configured to generate a second merging signal for the to-be-distributed tile when each SPC completes processing of the received to-be-distributed tile.

The SSG event merging module is configured to generate a tile group end signal upon receiving the first merging signal and all the second merging signals, and transmit the tile group end signal to the system-level event merging module.

The system-level event merging module is configured to generate a global end signal upon receiving tile group end signals from all super scalable groups, so as to complete the response to the total workload.

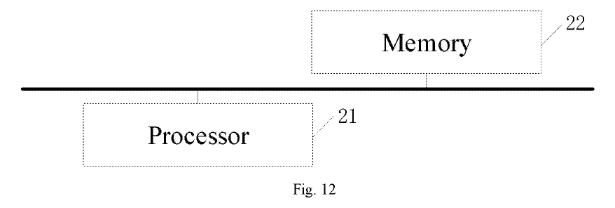

In another alternative embodiment, as shown in FIG. 12, it is a schematic architectural diagram of an apparatus for improving the scalability of GPU architecture according to an embodiment of the present invention. The apparatus for improving the scalability of GPU architecture in the present embodiment comprises one or more processors 21 and a memory 22. Herein, one processor 21 is taken as an example in FIG. 12.

The processor 21 and the memory 22 may be connected via a bus or other means, and connection via a bus is taken as an example in FIG. 12.

As a non-volatile computer-readable storage medium, the memory 22 may be used to store non-volatile software programs and non-volatile computer-executable programs, such as the method for improving the scalability of GPU architecture in the present embodiment. The processor 21 performs the method for improving the scalability of GPU architecture by running the non-volatile software programs and instructions stored in the memory 22.

The memory 22 may include a high-speed random access memory, or may also include non-volatile memory, such as at least one magnetic disk storage device, flash memory device, or other non-volatile solid-state storage device. In some embodiments, the memory 22 may optionally include the memory remotely located relative to the processor 21, and such remote memory may be connected to the processor 21 via a network. Examples of the aforementioned networks include, but are not limited to, the Internet, intranets, local area networks, mobile communication networks, and combinations thereof.

The program instructions/modules are stored in the memory 22, and when executed by one or more processors 21, implement the method for improving the scalability of GPU architecture in the above embodiments, for example, perform the steps of the method for improving the scalability of GPU architecture according to embodiments of the present invention as described above.

An embodiment of the present invention further provides a non-volatile computer storage medium having stored thereon computer-executable instructions. The computer-executable instructions, when executed by one or more processors, such as the processor 21 in FIG. 12, may cause one or more processors to implement the method for improving the scalability of GPU architecture in the specific embodiments of the present invention, for example, to perform the steps of the method for improving the scalability of GPU architecture according to embodiments of the present invention as described above, and may also implement the modules and units shown in FIG. 12; alternatively, the computer-executable instructions may cause one or more processors to implement the method for improving the scalability of GPU architecture in the specific embodiments of the present invention, for example, to perform the steps of the method for improving the scalability of GPU architecture according to embodiments of the present invention as described above, and may also implement the modules and units shown in FIG. 12.

It should be noted that the information interaction, execution process, and other contents among the modules and units in the above apparatus and system are based on the same concept as that of the embodiments of the processing method of the present invention. For specific contents, reference may be made to the descriptions in the embodiments of the method of the present invention, which will not be repeated here.

Those of ordinary skill in the art may understand that all or some of the steps of the various methods in the embodiments may be completed by a program instructing relevant hardware. The program may be stored in a computer-readable storage medium. The storage medium may include: Read Only Memory (ROM), Random Access Memory (RAM), magnetic disk, optical disk, and the like.

The above are only preferred embodiments of the present invention and are not intended to limit the present invention. Any modifications, equivalent substitutions, improvements, and the like made within the spirit and principles of the present invention shall all be included within the scope of protection of the present invention.

What is claimed is:

1. A method for improving the scalability of GPU architecture, comprising:
splitting, by a system-level common module, a total workload into a plurality of first-level workloads and distributing the first-level workloads to corresponding super scalable groups; and
splitting, by an SSG common module of each super scalable group, the first-level workloads into a plurality of second-level workloads and distributing the second-level workloads to corresponding SPCs, such that each SPC processes the received second-level workload.

2. The method for improving the scalability of GPU architecture according to claim 1, wherein the step of splitting, by a system-level common module, a total workload into a plurality of first-level workloads and distributing the first-level workloads to corresponding super scalable groups comprises:
splitting, by a system-level entry module of the system-level common module, the total workload into a plurality of first-level workloads of equal size when the system-level entry module receives a render start signal; and
distributing the plurality of first-level workloads of equal size to each super scalable group in sequence according to tile group credits from each super scalable group.

3. The method for improving the scalability of GPU architecture according to claim 2, wherein during initial distribution, the step of splitting, by a system-level entry module of the system-level common module, the total workload into a plurality of first-level workloads of equal size when the system-level entry module receives a render start signal comprises:
acquiring, by the system-level entry module, the number of SPCs in each super scalable group and the number of SEUs in each of the SPCs; calculating the product of the number of SPCs and the corresponding number of SEUs to obtain the total number of pipelines of the super scalable group;
acquiring the number of tiles corresponding to the total workload; calculating the ratio of the total number of pipelines to the number of tiles to obtain an initial distribution lower limit; and
splitting the total workload into a plurality of first-level workloads of equal size that are greater than or equal to the initial distribution lower limit.

4. The method for improving the scalability of GPU architecture according to claim 3, wherein during distribution, the distribution strategy adopted comprises Round-Robin mode or demand mode;
the Round-Robin mode refers to distributing tile groups to each SSG in a fixed order without considering the current actual performance of the SSGs, wherein the first-level workloads are distributed to each SSG in sequence until all the first-level workloads are distributed; and
the demand mode refers to dynamically distributing the first-level workloads according to the current actual performance of each SSG, the current actual performance comprising performance and load.

5. The method for improving the scalability of GPU architecture according to claim 3, wherein tile groups of equal size are distributed to each super scalable group.

6. The method for improving the scalability of GPU architecture according to claim 2, wherein the first-level workloads refer to the current sub-rendering tasks to be processed, and each sub-rendering task comprises tiles to be rendered and rendering parameters.

7. The method for improving the scalability of GPU architecture according to claim 2, wherein the step of distributing the plurality of first-level workloads of equal size to each super scalable group in sequence according to tile group credits from each super scalable group comprises:
determining the maximum tile group credit among the received tile group credits and distributing the first-level workload to the super scalable group corresponding to the maximum tile group credit; and
transmitting a tile group position offset corresponding to the first-level workload to the distributed super scalable group.

8. The method for improving the scalability of GPU architecture according to claim 7, wherein the tile group credit is the sum of all tile credits in the super scalable group;
or the tile group credit is the maximum value among all tile credits in the super scalable group.

9. The method for improving the scalability of GPU architecture according to claim 1, wherein when the first-level workload distributed by the system-level common module to the super scalable group corresponds to at least one to-be-distributed tile, the step of splitting, by an SSG common module of each super scalable group, the first-level workloads into a plurality of second-level workloads and distributing the second-level workloads to corresponding SPCs comprises:
determining at least one to-be-distributed tile corresponding to the first-level workload according to a tile group position offset, when an SSG entry module of the SSG common module receives the tile group position offset;
acquiring tile credits from each SPC, determining the maximum tile credit among the acquired tile credits, and distributing at least one to-be-distributed tile to the SPC corresponding to the maximum tile credit, so as to distribute the second-level workload to the corresponding SPC.

10. The method for improving the scalability of GPU architecture according to claim 9, wherein when the second-level workload corresponds to at least one skip tile, after each SPC processes the received second-level workload, the method further comprises:
determining at least one skip tile corresponding to the first-level workload in each super scalable group, and generating a first merging signal for the skip tile; generating a second merging signal for the to-be-distributed tile when each SPC completes processing the received to-be-distributed tile; generating a tile group end signal upon receiving the first merging signal and all the second merging signals;
generating a global end signal upon receiving tile group end signals from all super scalable groups, so as to complete the response to the total workload.

11. An apparatus for improving the scalability of GPU architecture, comprising a system-level common module and a plurality of super scalable groups, wherein each super scalable group comprises an SSG common module and a plurality of SPCs;
the system-level common module is configured to split a total workload into a plurality of first-level workloads and distribute the first-level workloads to the SSG common modules of corresponding super scalable groups; and
the SSG common module is configured to split the first-level workload into a plurality of second-level workloads and distribute the second-level workloads to corresponding SPCs, such that each SPC processes the received second-level workload.

12. The apparatus for improving the scalability of GPU architecture according to claim 11, wherein the SSG common module comprises an SSG entry module and an SSG cache;
the SSG entry module is configured to determine at least one to-be-distributed tile corresponding to the first-level workload according to a tile group position offset upon receiving the tile group position offset;
the SSG entry module is further configured to acquire tile credits from each SPC, determine the maximum tile credit among the acquired tile credits, and distribute at least one to-be-distributed tile to the SPC corresponding to the maximum tile credit, so as to distribute the second-level workload to the corresponding SPC; and
the SSG cache is configured to cache data required during the operation of each SPC for the second-level workloads contained in the SSG.

13. The apparatus for improving the scalability of GPU architecture according to claim 12, wherein the system-level entry module comprises a system-level request module, a system-level distribution module and a system-level event merging module; the SSG entry module comprises an SSG request module, an SSG distribution module, and an SSG event merging module;
the system-level distribution module is configured to split a total workload into a plurality of first-level workloads of equal size and distribute the plurality of first-level workloads of equal size to each SSG request module in sequence according to tile group credits from each super scalable group;
the SSG request module is configured to determine at least one skip tile corresponding to the first-level workload in each super scalable group, generate a first merging signal for the skip tile, and transmit the first merging signal to the SSG event merging module;
the SSG distribution module is configured to generate a second merging signal for the to-be-distributed tile when each SPC completes processing the received to-be-distributed tile;
the SSG event merging module is configured to generate a tile group end signal upon receiving the first merging signal and all the second merging signals, and transmit the tile group end signal to the system-level event merging module; and
the system-level event merging module is configured to generate a global end signal upon receiving tile group end signals from all super scalable groups, so as to complete the response to the total workload.

14. The apparatus for improving the scalability of GPU architecture according to claim 13, wherein a configuration register corresponding to the total workload transmits a render start signal to the system-level entry module, and upon receiving the render start signal, the system-level request module in the system-level entry module acquires tile groups to be rendered that are required for processing the total workload;
the system-level request module requests and acquires the tile groups to be rendered in tiled format on the screen from memory, wherein the tile groups comprise the screen coordinates of the tile groups and the base addresses of geometric data of primitives to be processed in the tile groups; after acquiring the tile groups, the system-level request module transmits them to the system-level distribution module, and the system-level distribution module distributes the tile groups to different super scalable groups, so as to split the total workload into a plurality of first-level workloads and distribute the same.

15. The apparatus for improving the scalability of GPU architecture according to claim 14, wherein after a to-be-distributed tile is distributed to an SPC, the SPC distributes and schedules the tile to a corresponding SEU in a graphics pipeline, so as to render the tile by a tile data acquisition module in the SEU; during distribution to the SEU, a tile position offset of the to-be-distributed tile is transmitted to the tile data acquisition module in the corresponding SEU; the to-be-distributed tile is transmitted from the tile data acquisition module to a raster image processing module for rendering.

16. The apparatus for improving the scalability of GPU architecture according to claim 13, wherein tile group position offsets are sequentially transmitted to the distributed super scalable groups via a separate first-in-first-out queue and/or a first-in-first-out module in the system-level distribution module.

17. The apparatus for improving the scalability of GPU architecture according to claim 13, wherein for a super scalable group, when the SSG request module acquires the last skip tile to be processed for the first-level workload from memory, a first merging signal is generated and transmitted to the SSG event merging module;
when the corresponding raster image processing module in the SPC completes rendering of the to-be-distributed tile, a second merging signal is generated and transmitted to the SSG event merging module; and
the SSG event merging module generates a tile group end signal upon receiving the first merging signal and all the second merging signals, and transmits the signal to the system-level event merging module in the system-level entry module.

18. The apparatus for improving the scalability of GPU architecture according to claim 13, wherein each SSG distribution module repeatedly acquires the to-be-distributed tile and skip tile corresponding to the first-level workload distributed to the super scalable group.

19. The apparatus for improving the scalability of GPU architecture according to claim 11, wherein the apparatus comprises one system-level common module and N+1 super scalable groups;
one super scalable group comprises M+1 SPCs and one SSG common module;
the M+1 SPCs are connected to the SSG common module; and
each SPC comprises a plurality of SEUs, a scheduler, and an SPC cache.

20. The apparatus for improving the scalability of GPU architecture according to claim 11, wherein one system-level common module is connected to each SSG common module in N+1 super scalable groups;
each super scalable group comprises M+1 SPCs and one SSG common module; and
the M+1 SPCs are connected to the SSG common module.
